(19) United States
(12) Patent Application Publication
(10) Pub. No.: US 2003/0046348 A1
(43) Pub. Date: Mar. 6, 2003

(54) System and method of converting video to bitmap animation for use in electronic mail

(76) Inventors: Albert Gregory Pinto, Anaheim Hills, CA (US); Malachi Daniel Clark, Costa Mesa, CA (US)

Correspondence Address: STETINA BRUNDA GARRED & BRUCKER, 75 ENTERPRISE, SUITE 250, ALISO VIEJO, CA, 92656, US

(21) Appl. No.: 09/941,828

(22) Filed: Aug. 29, 2001

(51) Int. Cl. G06F 15/16

(52) U.S. Cl. 709/206

(57) ABSTRACT

An animated e-mailable file, such as an advertisement, and a method of creating the animated e-mailable file are disclosed. The e-mailable file can be included as a non-attached, non-executable file to be played when an e-mail message including the animated e-mailable file is opened. The e-mailable animation file is created by: providing a source video file; selecting key video frames from the video frames of the source video file; selecting key audio segments from the audio track of the source video file; and synchronizing the key audio segments with the associated key video frames to produce an e-mailable animation file to be included as a non-attached, non-executable file in an e-mail message.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to computer animation, and more particularly to a system and method for converting video to animation for use in electronic mail (e-mail).

E-mail is the exchange of computer-stored messages via telecommunication. Typically, e-mail messages are encoded in ASCII text. Non-text files, such as graphic images, sound files, and video files containing both sound and graphic images, can also be sent as attachments in binary streams. There are problems with sending such files as e-mail attachments. Computer viruses can be transmitted using e-mail. The typical scenario for spreading viruses via e-mail is to include the virus as an attachment. The virus is activated when the message recipient opens the e-mail attachment. Due to the risk of a computer virus, many e-mail recipients avoid opening e-mail attachments unless they are certain that the contents do not contain a virus.

Thus, a need exists for a method for creating and sending an e-mail message that includes video, but minimizes the risk of transmitting viruses, as well as the fear that the message may contain a virus.

### BRIEF SUMMARY OF THE INVENTION

The present invention provides an e-mailable animation file and a method of creating the e-mailable animation file.

The e-mailable animation file is a non-attached, non-executable file comprising: a graphical component including a plurality of key video frames selected from a plurality of video frames of a source video file; and an audio component including a plurality of key audio segments selected the source video file, the key audio segments being synchronized to the key video frames. When the e-mail message including the e-mailable animation file is opened, the graphical component and the audio component are configured to play. The graphical component is displayed in a text viewing area of an e-mail user interface display and the audio component is played simultaneously with the display of the graphical component such that the key video frames are displayed simultaneously with associated key audio segments.

The method of creating the e-mailable animation file comprises: providing a source video file having a plurality of video frames and an audio track having a plurality of audio segments; selecting a plurality of key video frames from the video frames of the source video file; selecting a plurality of key audio segments from the audio track of the source video file; and synchronizing the key audio segments with the associated key video frames to produce an e-mailable animation file. The e-mailable animation file is configured to be included as a non-attached, non-executable file in an e-mail message such that the key video frames and associated audio segments play when the e-mail message is opened. When the key video frames are played they are displayed in a text viewing area of an e-mail user interface display. The source video file may be compressed prior to selecting the key video frames and key audio segments.

An e-mail message including the e-mailable animation file may be created. The e-mail message including the e-mailable animation file may be transmitted.

The e-mailable animation file may comprise a plurality of files, such as a video file and a plurality of audio files.

The e-mailable animation file may be an e-mailable advertisement file.

### BRIEF DESCRIPTION OF THE DRAWINGS

These as well as other features of the present invention will become more apparent upon reference to the drawings wherein:

FIG. 1 is a flow diagram illustrating exemplary logic for creating an e-mail message containing an animation that appears to be a video; and

FIG. 2 is exemplary Hypertext Markup Language(HTML) for sending an animated e-mail message created in a accordance with the present invention.

### DETAILED DESCRIPTION OF THE INVENTION

The present invention sends animated e-mail messages to users, for example by using Hypertext Markup Language (HTML) to send a flash file. Such messages can be used for a variety of purposes, for example, as advertisements (e.g., to promote products and/or services) or purely as entertainment. For example, an advertisement may be sent in an e-mail. Such an advertisement will automatically be viewed when the e-mail message is opened (e.g., as the text body of the e-mail message). This ensures that the target audience will view the animated advertisement.

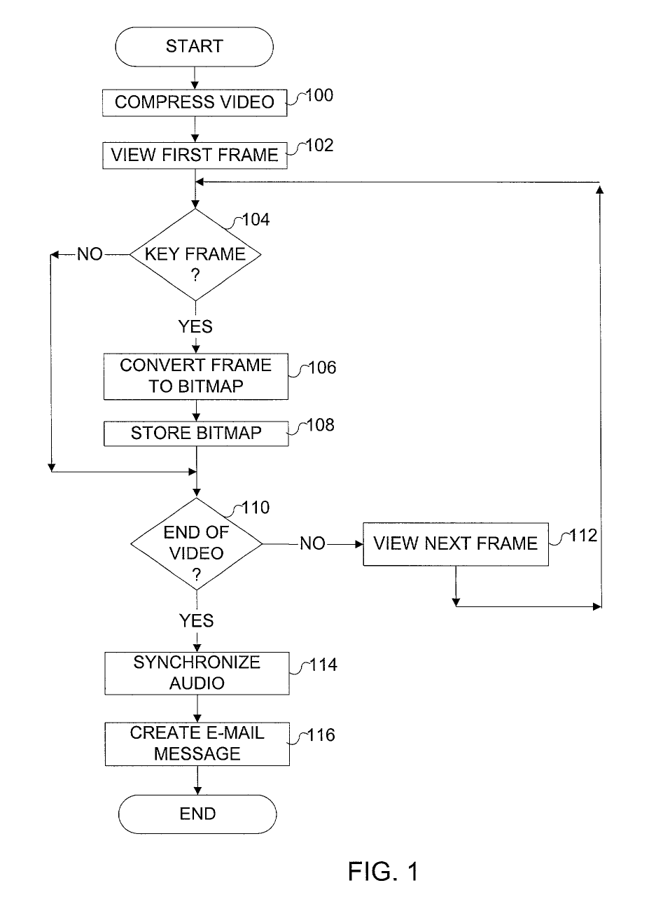

Referring now to the drawings wherein the showings are for purposes of illustrating preferred embodiments of the present invention only, and not for purposes of limiting the same, FIG. 1 is a flow diagram illustrating exemplary logic for creating an animated e-mail message in accordance with the present invention. The logic of FIG. 1 moves from a start block to block 100 where a selected video is compressed. The compression can be done using existing video compression programs, for example, Terran Media Cleaner or Adobe Premeire™. It will be appreciated that other compression programs may be used. After the video is compressed, it is viewed frame by frame, starting with the first frame (block 102). Next, the logic moves to decision block 104 where a test is made to determine if the frame is a key frame. Only key frames will be retained. Frames that are not key frames will be discarded and will not be part of the animated video. In exemplary embodiments, key frames are selected mathematically, e.g., every third frame. It will be appreciated that key frames can be determined in other ways. For example, the key frames may be viewed one by one and a user viewing the frames can select which frames to keep or a frame may be compared to a prior frame to determine the similarity between the frames. Frames falling below a specified threshold may be discarded. It will be appreciated that other methods for selecting key frames may be employed.

If the frame is a key frame, the logic moves from decision block 104 to block 106 where the key frame is converted to a bitmap. The logic then moves to block 108 where the bitmap is stored. Preferably, all of the bitmaps are stored in a single file. Alternatively, the bitmaps can be stored in separate files and later concatenated into a single file. Next, the logic moves to decision block 110 where a test is made to determine if it is the end of the video (i.e., the last frame has been viewed). If it is not the last frame of the video, the logic moves to block 112 where the next frame of the video is viewed. The logic then returns to decision block 104 to determine if the new frame is a key frame. The logic of blocks 104-112 are repeated until the last frame has been viewed.

When the last frame has been viewed, only the key frames (in bitmap form) remain. Display of the key frames in rapid succession produces an animation which is essentially a highly compressed, shortened version of the video.

Next, the logic proceeds to block 114 where the audio is synchronized with the animation sequence. In exemplary embodiments, there are several small audio files that are started at specific times in the video sequence. The video file includes markers indicating when a new audio file should be started. Having audio segments split into several small files allows for better synchronization because the configuration of the recipient's computer may cause the audio and video to play at different speeds than anticipated. Thus, even if the audio begins to lose synchronization with the video, the synchronization will be restored when the next audio file is played. It will be appreciated that various methods of synchronizing the audio may be employed. For example, the audio may be compressed. Compression of the audio may remove audio that is out of the audible range for humans, for example by removing all of the audio that is above a certain frequency. Typical audio compression techniques produce similar sounding audio that is a lower quality. Alternatively, audio may be played at a faster speed to match the video. As yet another alternative, the audio may be truncated such that original audio may simply stop at the time that the animation sequence stops. It will be appreciated that other techniques for synchronizing audio with animation may be used.

The animation (bitmaps with audio) is then used in the creation of an e-mail message. See block 116. The message created is an e-mail message that includes a non-executable video file, such as a flash file. The flash file uses a software plug-in to display the flash video in the text area of the e-mail message. Thus, video is displayed without the risk of a virus or even the fear of the potential threat a virus. In alternative embodiments, one or more of the techniques for compressing audio and video may be employed to format a suitably sized file based on the connection speed at which the e-mail message will be transmitted. Thus, the e-mail message for a lower speed connection will be more highly compressed than that of an e-mail message being sent over a higher speed connection.

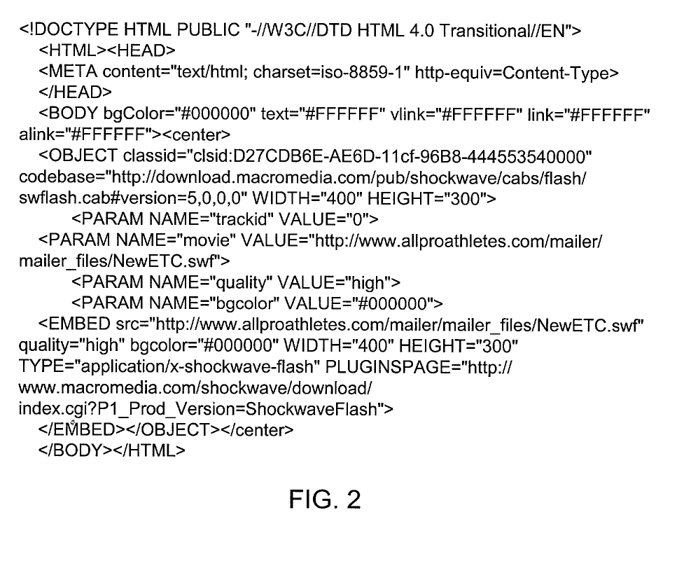

In the exemplary embodiment shown and described herein, the source video file is a single file including graphics and audio, for example, analog or digital raw video footage. The source file is then compressed. The audio and video portions of the compressed file are then separated. Key frames are then selected from the compressed video. The key frames are converted to bitmaps and stored in a flash file. The audio is then synchronized with the flash file. Preferably, the audio is divided into several small segments. Markers are placed in the flash file so that the audio segments are played simultaneously with the associated video frames. The flash file can then be sent in an e-mail message so that when the recipient opens the e-mail message the animation file (which appears to be a video) is displayed in the text window of the e-mail viewer. The synchronized audio is played simultaneously with the video. The flash file may be included in the message using HTML as shown in FIG. 2 and described below.

FIG. 2 is an example of HTML that can be used for sending an animation file created in accordance with the present invention. In the example shown in FIG. 2, the animation file is a flash file that contains the bitmaps (key frames selected from the compressed video) and the synchronized audio track. In the example shown in FIG. 2, an e-mail program executing on a server includes HTML which can be modified so that HTML such as that shown in FIG. 2 will be executed rather than displayed as text when the e-mail message is sent. As shown in FIG. 2, the video to be sent in the e-mail message can be a flash file (and associated audio files) that reside on a Web server that is accessible over the Internet.

When the recipient opens the e-mail message, the bitmaps are displayed in rapid sequence simultaneously with the audio stream. Thus, when the recipient opens the e-mail, the animation is automatically viewed and heard. The animation is viewed in the text viewing area, i.e., the area in which the text of a conventional e-mail message is displayed. If the e-mail is opened multiple times, the animation begins each time the message is opened. Since the e-mail animation does not include an executable, viruses or the user's fear of the e-mail containing a virus are diminished.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

What is claimed is:

1. A method of creating an e-mailable animation file, the method comprising:
a) providing a source video file having a plurality of video frames and an audio track having a plurality of audio segments;
b) selecting a plurality of key video frames from the video frames of the source video file;
c) selecting a plurality of key audio segments from the audio track of the source video file; and
d) synchronizing the key audio segments with the associated key video frames to produce an e-mailable animation file, the e-mailable animation file being configured to be included as a non-attached, non-executable file in an e-mail message such that the key video frames and associated audio segments play when the e-mail message is opened.

2. The method of claim 1, wherein when the key video frames are played, the key video frames are displayed in a text viewing area of an e-mail user interface display.

3. The method of claim 1, further comprising creating the e-mail message including the e-mailable animation file.

4. The method of claim 3, further comprising transmitting the e-mail message including the e-mailable animation file.

5. The method of claim 1, wherein step (a) further comprises compressing the source video file.

6. The method of claim 1, wherein the e-mailable animation file comprises a plurality of files.

7. The method of claim 1, wherein the e-mailable animation file is an e-mailable advertisement file.

8. An e-mail message comprising:
a) a non-attached, non-executable, e-mailable animation file comprising:
i) a graphical component including a plurality of key video frames selected from a plurality of video frames of a source video file; and
ii) an audio component including a plurality of key audio segments selected the source video file, the key audio segments being synchronized to the key video frames;
wherein when the e-mail message including the e-mailable animation file is opened, the graphical component and the audio component are configured to play, the graphical component being displayed in a text viewing area of an e-mail user interface display and the audio component being played simultaneously with the display of the graphical component such that the key video frames are displayed simultaneously with associated key audio segments.

9. An e-mailable animation file created by the method of:
a) providing a source video file having a plurality of video frames and an audio track having a plurality of audio segments;
b) selecting a plurality of key video frames from the video frames of the source video file;
c) selecting a plurality of key audio segments from the audio track of the source video file; and
d) synchronizing the key audio segments with the associated key video frames to produce an e-mailable animation file, the e-mailable animation file being configured to be included as a non-attached, non-executable file in an e-mail message such that the key video frames and associated audio segments play when the e-mail message is opened.

10. The method of claim 9, wherein when the key video frames are played, the key video frames are displayed in a text viewing area of an e-mail user interface display.

11. A method of creating an e-mailable animation advertisement file, the method comprising:
a) providing a source video advertisement file having a plurality of video frames and an audio track having a plurality of audio segments;
b) selecting a plurality of key video frames from the video frames of the source video advertisement file;
c) selecting a plurality of key audio segments from the audio track of the source video advertisement file; and
d) synchronizing the key audio segments with the associated key video frames to produce an e-mailable animation advertisement file, the e-mailable animation advertisement file being configured to be included as a non-attached, non-executable file in an e-mail message such that the key video frames and associated audio segments play when the e-mail message is opened.

12. The method of claim 11, wherein when the key video frames are played, the key video frames are displayed in a text viewing area of an e-mail user interface display.

13. The method of claim 11, further comprising creating the e-mail message including the e-mailable animation advertisement file.

14. The method of claim 13, further comprising transmitting the e-mail message including the e-mailable animation advertisement file.

15. The method of claim 11, wherein step (a) further comprises compressing the source video advertisement file.

16. The method of claim 11, wherein the e-mailable animation advertisement file comprises a plurality of files.

17. An e-mail advertisement message comprising:
a) a non-attached, non-executable, e-mailable animation advertisement file comprising:
i) a graphical component including a plurality of key video frames selected from a plurality of video frames of a source video advertisement file; and
ii) an audio component including a plurality of key audio segments selected the source video advertisement file, the key audio segments being synchronized to the key video frames;
wherein when the e-mail message including the e-mailable animation advertisement file is opened, the graphical component and the audio component are configured to play, the graphical component being displayed in a text viewing area of an e-mail user interface display and the audio component being played simultaneously with the display of the graphical component such that the key video frames are displayed simultaneously with associated key audio segments.

18. An e-mailable animation advertisement file created by the method of:
a) providing a source video advertisement file having a plurality of video frames and an audio track having a plurality of audio segments;
b) selecting a plurality of key video frames from the video frames of the source video advertisement file;
c) selecting a plurality of key audio segments from the audio track of the source video advertisement file; and
d) synchronizing the key audio segments with the associated key video frames to produce an e-mailable animation advertisement file, the e-mailable animation advertisement file being configured to be included as a non-attached, non-executable file in an e-mail message such that the key video frames and associated audio segments play when the e-mail message is opened.
